(19) United States
(12) Patent Application Publication
(10) Pub. No.: US 2010/0176046 A1
(43) Pub. Date: Jul. 15, 2010

(54) FILTRATION SYSTEM WITH A DUAL SEALING RING FILTER BASKET AND/OR A DUAL SEALING RING COLLAR FOR A FILTER ELEMENT

(75) Inventor: Michael A. Goldman, Boca Raton, FL (US)

Correspondence Address: FOX ROTHSCHILD LLP;PRINCETON PIKE CORPORATE CENTER, 997 LENOX DRIVE, BLDG. #3, LAWRENCEVILLE, NJ, 08648, US

(73) Assignee: Mechanical Manufacturing Corp., Sunrise, FL (US)

(21) Appl. No.: 12/351,923

(22) Filed: Jan. 12, 2009

(51) Int. Cl. B01D 27/08; B01D 35/30

(52) U.S. Cl. 210/232; 210/450

(57) ABSTRACT

Filter basket assemblies (108) and filter element assemblies (110) for use in a liquid filtering system (100). Each of the assemblies comprises ring gaskets (202, 204, 402, 404) and a body (or collar). The body (206, 706) has a continuous annular sidewall (208, 708) disposed around a central axis and a flange (210, 710) extending radially outward from the annular sidewall. The flange includes a first face (212, 712) and an opposing second face (214, 714). Each of the faces extends transverse to the annular sidewall. Each of the faces has one of the ring gaskets circumferentially disposed thereon around the central axis. The ring gaskets can have the same or different diameters. The first ring gasket can be positioned coaxial with the second ring gasket.

### BACKGROUND OF THE INVENTION

1. Statement of the Technical Field

The invention concerns filtration systems. More particularly, the invention concerns filtration systems with dual o-ring filter baskets and/or dual o-ring collars for filter elements.

2. Description of the Related Art

A filtration system typically consists of a filter element assembly for use in a pressurized filter system. The filter element assembly typically includes a plastic collar coupled to a cylindrical filter element. The filter element is closed at one end and fused to the plastic collar at an opposing end. The filter element is composed of one or more layers of filtering medium. The filtering medium is typically made of a micro-fiber material having pores to control fluid flow. The layers of filtering medium can have a uniform pore structure, a graded pore structure, or a tapered pore structure. A tapered or graded pore structure provides a filtering material whereby the pore size decreases in the direction of fluid flow. A multi-layer filter structure provides a filtering system able to collect contaminants at each layer of filtering medium.

The pressurized filter system utilizing the filter element assembly is typically comprised of a filter housing and a housing lid. The filter housing often includes a removable filter basket disposed therein for supporting the filter element. The filter basket and the plastic collar of the filter element assembly rest in an annular channel disposed in the top of the filter housing. The housing lid is removably secured to the top of the filter housing. When the housing lid is closed and secured, an o-ring seal disposed on or in the housing lid forms a seal with an upper surface of the filter housing. A contaminated fluid is pumped into the filter housing through an input orifice of the filter housing. The contaminated fluid is filtered as it flows through the filter element and then exists through an output orifice of the filter housing.

One problem with the forgoing arrangement is that the o-ring seal disposed on the housing lid can sometimes leak, thereby causing undesirable results. As such, there is a need for an improved filtration system configured to form a fluid-tight seal between the filter housing and the housing lid.

### SUMMARY OF THE INVENTION

This summary is provided to comply with 37 C.F.R. §1.73, presenting a summary of the invention briefly indicating the nature and substance of the invention. It is submitted with the understanding that it will not be used to interpret or limit the scope or meaning of the claims.

Embodiments of the present invention concern filter element assemblies for use in a liquid filtering system. The filter element assemblies comprise ring gaskets, a collar, and a filter element. The ring gaskets can be formed of a resilient material that can deform in response to a compressive force exerted thereon so as to form a fluid-tight seal between the flange and a surrounding structure (e.g., a filter housing and/or cover). Such materials include, but are not limited to, an elastomeric material or a fluoropolymer material. The collar generally includes annular sidewall disposed around a central axis and a flange extending radially outward from the annular sidewall. The flange has a first face and an opposing second face. Each of the faces extends traverse to the annular sidewall. Each of the faces has an ring gasket disposed thereon. The ring gaskets can have the same or different diameters. The ring gaskets are in vertical alignment with each other, i.e., a first ring gasket is coaxial with a second ring gasket. The filter element is formed from one or more layers that are coextensive with a surface thereof. The filter element has a tubular form that is closed at first end and affixed to the annular sidewall at a second end opposed to the first end so as to define an input orifice of the filter element.

According to one aspect of the present invention, the flange has an annular channel formed in the first face sized and shaped to receive a first one of the ring gaskets. The annular channel can be defined by a u-shaped recess formed in the surface of the first face. The annular channel can also be defined by a notch formed along a peripheral edge of the first face. The flange also comprises a third face that extends perpendicularly from the second face. The third face has a second one of the sealing members extending radially therearound. The second ring gasket can be sized and shaped so that an inner circumference resiliently engages the third face when extended radially therearound.

Embodiments of the present invention also concern an apparatus for filtering fluids. The apparatus includes a housing, a cover removably secured to the housing, a first ring gasket, a filter element assembly, and a support structure for supporting the filter element assembly in the housing. An ring gasket is circumferentially disposed around a central axis between the housing and the cover so as to provide a first seal therebetween. The filter element assembly can be the same as or substantially similar to the filter element assembly described above. The support structure can include a filter basket removably disposed in the housing.

The filter basket can comprise an annular sidewall disposed around the central axis and a flange extending radially outwardly from the annular sidewall. The flange can include a first face and an opposing second face. Each of the faces extends traverse to said annular sidewall. The first face can have an ring gasket disposed thereon. Similarly, the second face can have an ring gasket disposed thereon. The ring gaskets are in vertical alignment with each other.

### BRIEF DESCRIPTION OF THE DRAWINGS

Embodiments will be described with reference to the following drawing figures, in which like numerals represent like items throughout the figures, and in which:

FIG. 1 is a schematic illustration of a filtration system that is useful for understanding the present invention.

FIG. 2 is a perspective view of an exemplary embodiment of the filter basket of FIG. 1.

FIG. 3 is a cross-sectional view of the exemplary embodiment of the filter basket of FIG. 2 taken along lines 3-3 of FIG. 2.

FIG. 4 is a schematic illustration of the sealing members of FIGS. 2-3 providing fluid-tight seals between the exemplary filter basket of FIGS. 2-3 and surrounding structures.

FIG. 5 is a perspective view of the filter element assembly of FIG. 1.

FIG. 6 is a diagram of filter materials used to form the filter element of FIG. 5.

FIG. 7 is a perspective view of an exemplary embodiment of the collar absent of the handles.

FIG. 8 is a cross-sectional view of the exemplary embodiment of the collar of FIG. 7 taken along lines 8-8 of FIG. 7.

FIG. 9 is a schematic illustration of the sealing members of FIGS. 7-8 providing fluid-tight seals between the exemplary collar of FIGS. 7-8 and surrounding structures.

FIG. 10 is a top view of a ring gasket.

FIG. 11 is a cross-sectional view of the ring gasket taken along line 11-11 of FIG. 10.

FIG. 12 is a perspective view of a collar having a first exemplary handle coupled thereto via a hook.

FIG. 13 is a cross sectional view of the collar of FIG. 12 taken along lines 13-13 of FIG. 12.

FIG. 14 is a perspective view of a second exemplary handle that can be coupled to a collar having a plurality of substantially L-shaped notches formed in an inner sidewall thereof.

### DETAILED DESCRIPTION OF THE PREFERRED EMBODIMENTS

The present invention is described with reference to the attached figures, wherein like reference numbers are used throughout the figures to designate similar or equivalent elements. The figures are not drawn to scale and they are provided merely to illustrate the instant invention. Several aspects of the present invention are described below with reference to example applications for illustration. It should be understood that numerous specific details, relationships, and methods are set forth to provide a full understanding of the invention. One having ordinary skill in the relevant art, however, will readily recognize that the invention can be practiced without one or more of the specific details or with other methods. In other instances, well-known structures or operation are not shown in detail to avoid obscuring the invention.

Before describing the systems and methods of the present invention, it will be helpful in understanding an exemplary environment in which the invention can be utilized. In this regard, it should be understood that the systems and methods of the present invention can be utilized in a variety of different applications where organic contaminants, color, odor, or even chlorination need to be removed from liquids or fluids. Such applications include, but are not limited to, water filtration applications, oil filtration application, paint filtration applications, air filtration applications, gas filtration applications, and exhaust filtration applications.

The word “exemplary” is used herein to mean serving as an example, instance, or illustration. Any aspect or design described herein as “exemplary” is not necessarily to be construed as preferred or advantageous over other aspects or designs. Rather, use of the word exemplary is intended to present concepts in a concrete fashion. As used in this application, the term “or” is intended to mean an inclusive “or” rather than an exclusive “or”. That is, unless specified otherwise, or clear from context, “X employs A or B” is intended to mean any of the natural inclusive permutations. That is if, X employs A; X employs B; or X employs both A and B, then “X employs A or B” is satisfied under any of the foregoing instances.

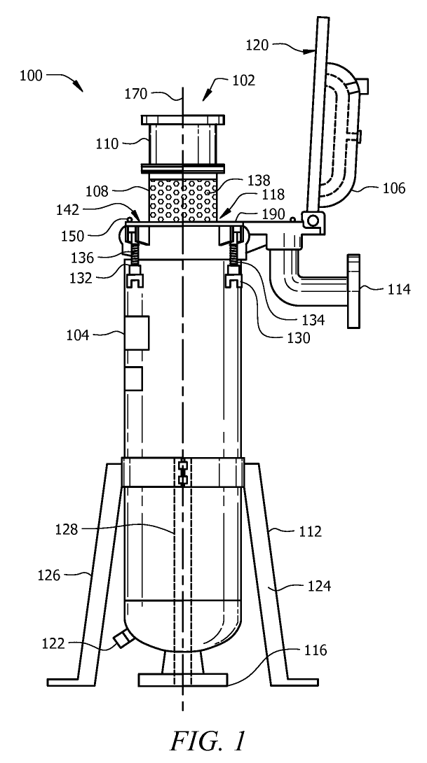

FIG. 1 shows an exemplary filtration system 100 that is useful for understanding embodiments of the present invention. Although the filtration system 100 shown in FIG. 1 has a vertical configuration, embodiments of the present invention are not limited in this regard. For example, the present invention can be used in a filtration system having a vertical configuration (as shown in FIG. 1) and/or a horizontal configuration (not shown).

As shown in FIG. 1, the filtration system 100 comprises a pressurized filter housing 102 having a body 104 and a cover 106 in an open position. The filter housing 102 is comprised of a mounting stand 112, an input orifice 114, an output orifice 116, and a drain 122. Although the input orifice 114 is located at the top of the filter housing 102 as shown in FIG. 1, embodiments of the present invention are not limited in this regard. For example, the input orifice 114 can be located at the bottom of the filter housing 102. In such a scenario, the output orifice 116 is located at the top or a side of the filter housing 102 (rather than on the bottom of the filter housing 102 as shown in FIG. 1).

The mounting stand 112 includes a plurality of legs 124, 126, 128. The filter housing 102 is also comprised of a pair of locking bar nuts 130, 132 disposed on pivotable bolts 134, 136, respectively. The locking bar nuts and bolts 130, 132, 134, 136 facilitate the securement of the cover 106 to the filter housing 102. The filter housing 102 also comprises at least one sidewall 190 defining an interior space 190 configured for receiving a filter element assembly 110 therein. The cover 106 is secured to the filter housing 102 so as to be removable from a first position, in which the cover 106 encloses the interior space 192, and a second position, in which the interior space 192 is accessible for receiving the filter element assembly 110 therein.

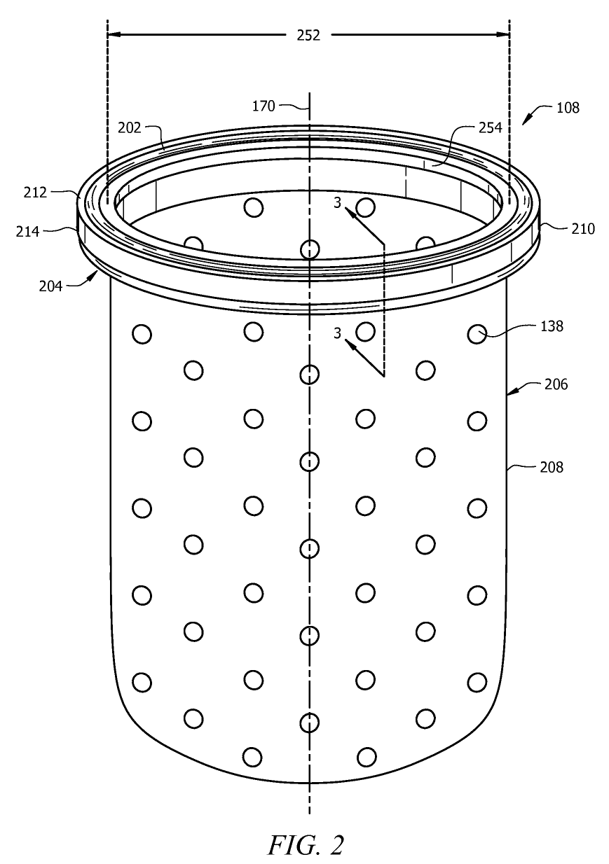

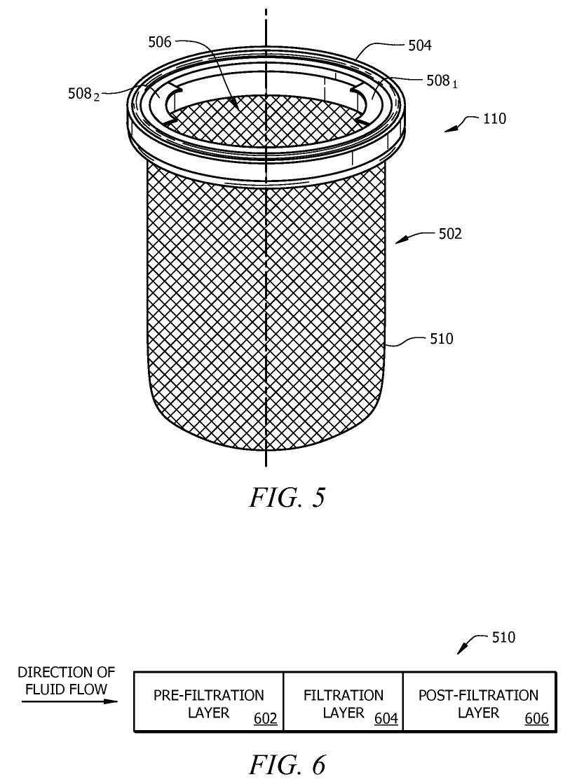

The filtration system 100 also comprises a filter basket 108 having the filter element assembly 110 placed therein. The filter basket 108 supports the filter element assembly 110 in the filter housing 102. The filter basket 108 has apertures 138 formed therein for permitting liquids and/or fluids to pass therethrough. The filter basket 108 will be described in more detail below in relation to FIGS. 2-4. The filter element assembly 110 will be described in more detail below in relation to FIG. 5-9.

During operation, the cover 106 is in its closed position (not shown). In the closed position, the cover 106 applies a downward pressure (or compressive force) on an ring gasket 150 circumferentially disposed around a central axis 170 between the filter housing 102 and the cover 106. As a result of the applied pressure (or compressive force), the ring gasket 150 provides a seal between the filter housing 102 and the cover 106. The cover also applies a downward pressure (or compressive force) on the filter basket 108 and/or the filter element assembly 110 resting in an annular channel 118 disposed in the top of the filter housing 102. As a result of the applied pressure (or compressive force), at least one of the filter components 108, 110 provides a fluid-tight seal between itself and the filter housing 102. The filter component(s) 108, 110 also provides a fluid-tight seal between itself and a surface 120 of the cover 106. A contaminated liquid or fluid (not shown) is then pumped into the filter housing 102 through the input orifice 114. The contaminated liquid or fluid (not shown) is filtered as it flows through the filter element assembly 110 and then exists the filter housing 102 through the output orifice 116 thereof.

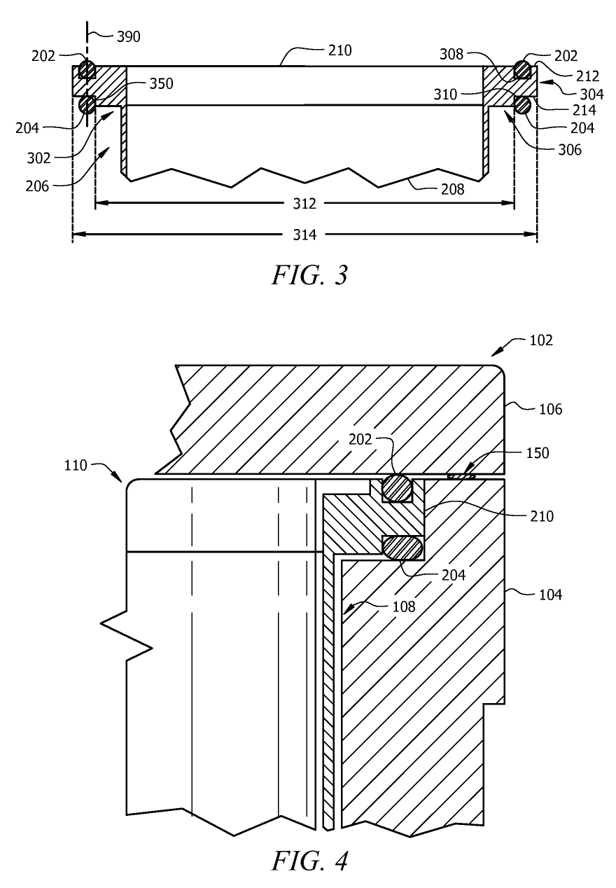

An exemplary embodiment of the filter basket 108 will now be described in relation to FIGS. 2-3. FIG. 2 provides a perspective view of the exemplary embodiment of the filter basket 108. FIG. 3 is a cross-sectional view of the exemplary embodiment of the filter basket 108 taken along lines 3-3 of FIG. 2. As shown in FIGS. 2-3, the filter basket 108 can comprise ring gaskets 202, 204 and a body 206. Embodiments of the present invention are not limited in this regard. For example, the filter basket 108 can be absent of the ring gaskets 202, 204. In such a scenario, the filter element assembly 110 (described above in relation to FIG. 1) can include the ring gaskets (as shown in FIGS. 5-9). The filter basket 108 can have any dimensions (e.g., length and width) selected in accordance with a particular filtration application.

The body 206 generally includes a continuous annular sidewall 208 disposed around the central axis 170 and a flange 210 extending radially outward from an edge 302 of the annular sidewall 208. Embodiments of the present invention are not limited in this regard. For example, the body 206 can include an annular sidewall 208 and a collar (not shown) coupled thereto. The collar (not shown) can have the ring gaskets 202, 204 disposed thereon so as to be vertically aligned with respect to each other, i.e., a first ring gasket 202 is coaxial with the second ring gasket 204. The body 206 can also include a hollow member (not shown) projecting inward from a bottom surface thereof. The hollow member (not shown) can have apertures (not shown) formed therein for permitting liquids and/or fluids to pass therethrough. The hollow member (not shown) can be provided to support a filter element (not shown) configured for filtering a fluid flowing from an outer surface (not shown) thereof to an inner surface (not shown) thereof.

Referring again to FIGS. 2-3, the annular sidewall 208 can have any shape selected in accordance with a particular filtration application. Such shapes include, but are not limited to, circular shapes (as shown in FIG. 2), hex shapes (not shown), and rectangular shapes (not shown). Similarly, the flange (or collar) 210 can have any shape selected in accordance with a particular filtration system application. For example, the flange (or collar) 210 can have a circular shape (as shown in FIG. 2), a hex shape (not shown), and/or a rectangular shape (not shown). For convenience, the invention is described in terms of a circular profile. Those skilled in the art will appreciate that different shaped ring gaskets 202, 204 will be required for alternatively shaped flanges 210.

As shown in FIGS. 2-3, the flange (or collar) 210 has a first face 212 and an opposing second face 214. Each of the faces 212, 214 has a respective ring gasket 202, 204 disposed thereon. Notably, the ring gaskets 202, 204 are in vertical alignment with each other. The ring gasket 202 is advantageously positioned coaxial to the o-ring gasket 204. In this coaxial position, the central y-axis 390 of the ring gaskets 202, 204 can be aligned with each other (as shown in FIG. 3). The rings gasket 202 is disposed at a first location 254 on the first face 212 that is aligned with a second location (not visible in FIG. 2) on the second face 214 at which the second ring gasket 204 is disposed. This vertical alignment of the ring gaskets 210, 212 ensures that fluid-tight seals are formed between the flange (or collar) 210 and a surrounding structure (e.g., the pressurized filter housing 102 of FIG. 1). The fluid-tight seals prevent the escape of liquids and/or fluids from the pressurized filter housing 102 when they are being pumped therethrough.

According to embodiments of the present invention, the ring gaskets 202, 204 are of approximately equal inside diameters (e.g., diameter 1108 of FIG. 11). Similarly, the ring gaskets 202, 204 can have approximately equal radial cross sections (e.g., radial cross section 1104 of the ring gasket 1000 shown in FIGS. 10-11) and axial cross sections (e.g., axial cross section 1102 of the ring gasket 1000 shown in FIGS. 10-11). Still, embodiments of the present invention are not limited in this regard. For example, ring gaskets 202, 204 can have respective inside diameters, radial cross sections, and axial cross sections that are different relative to each other.

As shown in FIG. 3, the flange (or collar) 210 comprises a first flange structure 304 and a second flange structure 306 coupled to the first flange structure 304. The first and second flange structures 304, 306 can be integrally formed as shown in FIGS. 2-3. However, embodiments of the present invention are not limited in this regard. For example, the second flange structure 306 can be a separate component coupled to the first flange structure 204 via any suitable adhesive or coupling means.

The first flange structure 304 can include the first and second faces 212, 214. The first face 212 can have an annular channel 308 formed therein sized and shaped to receive at least a portion of the sealing member 202. The channel 308 can be defined by a u-shaped recess (as shown in FIG. 3) formed in the first face 212 or a notch (not shown) formed along a peripheral edge of the first face 212.

The ring gasket 202 can snuggly fit in the channel 308 or be captured in the channel 308. The ring gasket can also be coupled to the channel 308 via an adhesive or other suitable coupling means. In any event, the ring gasket 202 can form seal a against the walls of the channel 308.

The second flange structure 306 can have an outer diameter 312 smaller than the outer diameter 314 of the first flange structure 304. The second flange structure 306 has a third face 350 extending transversely or perpendicularly from the second face 214 of the first flange structure 304. The second flange structure 306 has the ring gasket 204 extending around a periphery of its circumferential edge portion 310. More particularly, the third face 350 has the ring gasket 204 extending therearound. Accordingly, the second ring gasket 204 is sized and shaped so that an inner circumference resiliently engages the circumferential edge portion 310 and the third face 350 when extended around the periphery of the second flange structure 306.

The ring gasket 204 can be snuggly fitted around the third face 350 or coupled to one or more of the flange structures 304, 306 via an adhesive or other suitable coupling means. In any event, the ring gasket 204 can form a seal against the second face 214 of the first flange structure 304 and the third face 350 of the second flange structure 306.

It should be noted that embodiments of the present invention are not limited to the second flange structure 306 configuration described above. For example, the second flange structure 306 can alternatively include a channel (not shown) sized and shaped to receive at least a portion of the ring gasket 204. In such a scenario, the channel (not shown) of the second flange structure 306 can be vertically aligned with the channel 308 of the first flange structure 304, i.e., the channel (not shown) of the second flange structure 306 can reside directly below the channel 308 of the first flange structure 304.

The ring gaskets 202, 204 are formed of a resilient material that deforms in response to a compressive force exerted thereon so as to form a fluid-tight seal between the body 206 and a surrounding structure (e.g., the cover 106 shown in FIG. 1 and the housing 104 shown in FIG. 1). Such materials include, but are not limited to, elastomeric materials (e.g., a silicone rubber), or fluoropolymer materials. The ring gaskets 202, 204 can have any shape selected in accordance with a particular filtration system application provided that the shape corresponds to a profile of the flange structure. For example, the ring gaskets 202, 204 can have a circular shape (as shown in FIG. 2), a hex shape (not shown), and/or a rectangular shape (not shown). The ring gaskets 202, 204 can have the same or different diameters.

A schematic illustration of the ring gaskets 202, 204 of the filter basket 108 providing fluid-tight seals between the filter basket 108 and the surrounding structures (e.g., the pressurized filter housing 102 of FIG. 1) is provided in FIG. 4. As shown in FIG. 4, the ring gasket 202 is disposed between the flange 210 of the filter basket 108 and the cover 106 of the pressurized filter housing 102 so as to form a fluid-tight seal therebetween. Similarly, the ring gasket 204 is disposed between the flange and the body 104 of pressurized filter housing 102 so as to form a fluid-tight seal therebetween.

It should be noted that the fluid-tight seals are provided when a pressure is applied to the filter basket 108 by the cover 106 of the pressurized filter housing 102. As a result of the fluid-tight seals, the dual ring basket design provides a filtration system 100 with maximum sealing efficiency that is achieved with minimal effort and force.

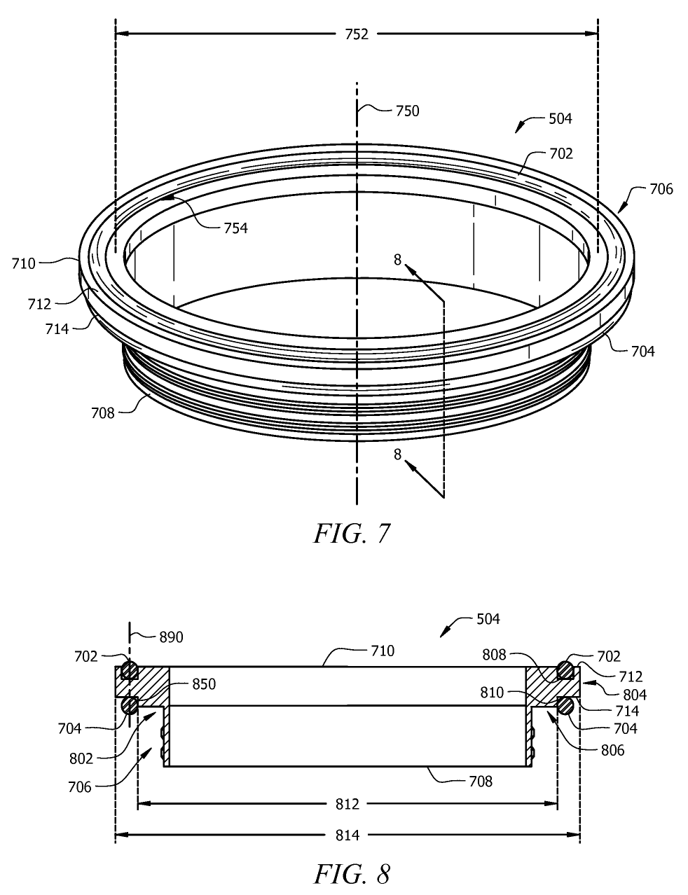

The filter element assembly 110 will now be described in relation to FIGS. 5-6. A perspective view of the filter element assembly 110 is provided in FIG. 5. As shown in FIG. 5, the filter element assembly 110 includes a filter element 502 affixed to a collar 504. The filter element assembly can have any dimensions (length and width) selected in accordance with a particular filtration application. The collar 504 can comprise one or more handles 5081, 5082 for facilitating the removal of the filter element assembly 110 from the pressurized filter housing 102 (shown in FIG. 1). The collar 504 can be made of a semi-rigid material, such as a thermoplastic. The collar 504 will be described in detail below in relation to FIGS. 7-9.

The filter element 502 is formed from a filter material 510 that is coextensive with a surface thereof. The filter element 502 has a tubular form that is closed at a first end and affixed to the collar 504 at a second end opposed to the first end so as to define an input orifice 504 of the filter element assembly 110. The filter material 510 can include one or more layers of filtering medium having a number of pores to control fluid flow. The filtering medium can be selected to comprise a material that is suitable for a particular filtration application. Such materials include, but are not limited to, a micro-fiber (e.g. a polyester, polypropylene, fiberglass, polyamide, or fluorocarbon) or a monofilament (e.g. a nylon or a polypropylene monofilament). The filter material 510 can have an identical pore structure, a graded pore structure, or a tapered pore structure. A tapered or graded pore structure provides a filter material 510 whereby a pore size can decrease in the direction of fluid flow, i.e. from an input orifice 506 of the filter element assembly 110 through the filter element 502.

Referring now to FIG. 6, there is provided a diagram of the structure of a filter material 510 used to form the filter element 502. As shown in FIG. 6, the filter material 510 can comprise a pre-filtration layer 602, a filtration layer 604, and a post-filtration layer 606. Each layer 602, 604, 606 can be co-extensive with an entire surface area of the filter element 502. The pre-filtration layer 602 is the inside layer, and thus would be the inside of the filter element 502. The pre-filtration layer 604 can be referred to as the upstream layer. The post-filtration layer 606 is the outside layer, and thus would be the outside of the filter element 502. The post-filtration layer 606 can be referred to as the downstream layer. The pre-filtration layer 602, the filtration layer 604, and the post-filtration layer 606 can be joined to each other. For example, the pre-filtration layer 602, the filtration layer 604, and the post-filtration layer 606 can be joined using an ultrasonic welding technique.

The pre-filtration layer 602 can include a pre-filter material which can be co-extensive with an entire surface area of the filter element. The pre-filter material can comprise one or more layers of a pre-filtering medium. The pre-filtering medium can comprise a monofilament (e.g. nylon monofilament) and/or a micro-fiber (e.g. a polypropylene micro-fiber). The pre-filtration layer 602 can collect large particles from a fluid being pumped through the filter element 502.

The pre-filtration material can further comprise one or more layers of an adsorbent medium for removing chlorine, odor, sediment, or other organic contaminants from a fluid. The adsorbent medium can be composed of a granular material (not shown) disposed between thin wall substrates (not shown). The adsorbent medium (not shown) can be fixed between the thin wall substrates (not shown) or embedded in fibers of the thin wall substrates (not shown) using any physically restrictive method commonly used in the art for manufacturing an adsorbent medium, such as a wet bonding technique, a heat bonding technique, an entangling method, or a pressure bonding technique. The granular material (not shown) can be selected to include activated carbon and/or activated charcoal. The activated carbon and/or activated charcoal can be selected to have a large surface area for providing bonding sites for contaminant adsorption.

The pre-filtration material can also include one or more layers of a diffusion medium (not shown) to act as spacers between the layers of a pre-filtering medium and/or an adsorbent medium. In such a scenario, the pre-filtration material can include alternating layers of the adsorbent medium (not shown) and the diffusion medium (not shown). The diffusion medium (not shown) can be made from any suitable material that is temperature and fluid compatible with the filtering application to be carried out. For example, the diffusion medium (not shown) can be made of a thermoplastic having polypropylene for low temperature filtering applications. The diffusion medium (not shown) can be made of a thermoplastic having nylon for high temperature filtering applications. The diffusion medium (not shown) can be composed of a mesh material. For example, the diffusion medium (not shown) can comprise a non-adsorbent mesh material formed of a plurality of parallel strands defining lateral passages transverse to layers of adsorbent medium. The lateral passages diffuse a liquid and/or a fluid over a surface area of a layer of adsorbent medium (not shown) downstream therefrom.

The filtration layer 604 can include a filter material which can be co-extensive with an entire surface area of the filter element. The filter material can comprise one or more layers of a filtering medium. The filtering medium can be selected to include an absolute-rated micro-fiber. The filtering medium can also be selected to include synthetic fibers, e.g., polyester or polypropylene. The filtering medium can collect particles of contaminants from a fluid being pumped through the filter element.

The filter material can further comprise one or more layers of the adsorbent medium for removing organic contaminants from a fluid. The adsorbent medium can be the same as or substantially similar to the adsorbent medium described above in relation to the pre-filtration material. The filter material can also include one or more layers of a diffusion medium to act as spacers between the layers of a filtering medium and/or an adsorbent medium. The diffusion medium can be the same as or substantially similar to the diffusion medium described above in relation to the pre-filtration material.

The filtration layer 604 can also include a support medium which can be co-extensive with an entire surface area of the filter element. The support medium can be a structural layer composed of a monofilament, such as a polypropylene monofilament. The support medium can be joined to the filter material. For example, the support medium can be joined to the filter material using an ultrasonic welding technique. The support medium can provide structural support to the filter element for sustaining high pressure fluid flow.

The post-filtration layer 606 can comprise a support jacket which can be co-extensive with the surface area of the filter element. For example, the support jacket can be composed of a fibrous fabric, such as a non-woven spunbond material. The support jacket can provide support to the filter element and prevent fiber migration downstream.

An exemplary embodiment of the collar 504 will now be described in relation to FIGS. 7-8. FIG. 7 provides a perspective view of the exemplary embodiment of the collar 504 absent of the handles 508₁, 508₂. FIG. 8 is a cross-sectional view of the exemplary embodiment of the collar 504 taken along lines 8-8 of FIG. 7. As shown in FIGS. 7-8, the collar 504 comprises ring gaskets 702, 704 and a body 706. Embodiments of the present invention are not limited in this regard. For example, the collar 504 can be absent of the ring gaskets 702, 704. In such a scenario, the filter basket 108 (described above in relation to FIG. 1) can include the ring gaskets (as shown in FIGS. 2-4).

The body 706 generally includes an annular sidewall 708 disposed around a central axis and a flange 710 extending radially outward from an edge 802 of the annular sidewall 708. The annular sidewall 708 can have any shape selected in accordance with a particular filtration application. Such shapes include, but are not limited to, circular shapes (as shown in FIG. 7), hex shapes (not shown), and rectangular shapes (not shown). Similarly, the flange 710 can have any shape selected in accordance with a particular filtration system application. For example, the flange 710 can have a circular shape (as shown in FIG. 7), a hex shape (not shown), and/or a rectangular shape (not shown). For convenience, the invention is described in terms of a circular profile. Those skilled in the art will appreciate that different shaped ring gaskets 702, 704 will be required for alternatively shaped flanges 710.

As shown in FIGS. 7-8, the flange 710 has a first face 712 and an opposing second face 714. Each of the faces 710, 714 extends traverse to the annular sidewall 708. Each of the faces 710, 714 has a respective ring gasket 702, 704 disposed thereon around the central axis 170. Notably, the ring gaskets 702, 704 are in vertical alignment with each other. The ring gasket 702 is advantageously positioned coaxial to the ring gasket 704. In this coaxial position, the central y-axis 890 of the ring gaskets 702, 704 can be aligned with each other (as shown in FIG. 8). The ring gasket 702 is disposed at a first location 754 on the first face 712 that is aligned with a second location (not visible in FIG. 2) on the second face 714 at which the second ring gasket 704 is disposed. This vertical alignment of the ring gaskets 702, 704 ensures that fluid-tight seals are formed between the flange 710 and a surrounding structure (e.g., the pressurized filter housing 102 of FIG. 1). The fluid-tight seals prevent the escape of liquids and/or fluids from the pressurized filter housing 102 when they are being pumped therethrough.

According to embodiments of the present invention, the ring gaskets 202, 204 are of approximately equal inside diameters (e.g., diameter 1108 of FIG. 11). Similarly, the ring gaskets 202, 204 can have approximately equal radial cross sections (e.g., radial cross section 1104 of the ring gasket 1000 shown in FIGS. 10-11) and axial cross sections (e.g., axial cross section 1102 of the ring gasket shown in FIGS. 10-11). Still, embodiments of the present invention are not limited in this regard. For example, ring gaskets 202, 204 can have respective inside diameters, radial cross sections, and axial cross sections that are different relative to each other.

As shown in FIG. 8, the flange 710 comprises a first flange structure 804 and a second flange structure 806 coupled to the first flange structure 804. The first and second flange structures 804, 806 can be integrally formed as shown in FIGS. 7-8. However, embodiments of the present invention are not limited in this regard. For example, the second flange structure 806 can be a separate component coupled to the first flange structure 804 via any suitable adhesive or coupling means.

The first flange structure 804 can include the first and second faces 712, 714. The first face 712 can have an annular channel 808 formed on the first face 712 sized and shaped to receive at least a portion of the sealing member 702. The annular channel 808 can be defined by a u-shaped recess (shown in FIG. 8) formed in the surface of the first face 712 or a notch (not shown) formed along a peripheral edge of the first face.

The ring gasket 702 can be snuggle fitted or captured in the channel 808. The ring gasket 702 can also be coupled to the channel 808 via an adhesive or other coupling means. In any event, the ring gasket 702 can form a seal against the walls of the channel 808.

The second flange structure 806 has an outer diameter 812 smaller than the outer diameter 814 of the first flange structure 804. The second flange structure 806 has a third face 850 extending transversely or perpendicularly from the second face 714 of the first flange structure 804. The second flange structure 806 has the ring gasket 704 extending around a periphery of its circumferential edge portion 810. More particularly, the third face 850 has the ring gasket 204 extending therearound. Accordingly, the second ring gasket 704 is sized and shaped so that an inner circumference resiliently engages the circumferential edge portion 810 and the third face 850 when extended around the periphery of the second flange structure 806.

The ring gasket 704 can be snuggly fitted to the flange structures 804, 806. Embodiments of the present invention are not limited in this regard. For example, the ring gasket 704 can be elastically secured to flange 806 of coupled to one or more of the flange structures 804, 806 via an adhesive or other suitable coupling means. In any event, the ring gasket 704 can form a seal against the second face 714 of the first flange structure 804 and the periphery of the second flange structure 806.

It should be noted that embodiments of the present invention are not limited to the second flange structure 806 configuration described above. For example, the second flange structure 806 can alternatively include a channel (not shown) sized and shaped to receive at least a portion of the ring gasket 704. In such a scenario, the channel (not shown) of the second flange structure 806 can be vertically aligned with the channel 808 of the first flange structure 804, i.e., the channel (not shown) of the second flange structure 806 can reside directly below the channel 808 of the first flange structure 804.

The ring gaskets 702, 704 can be formed of a resilient material that can deform in response to a compressive force exerted thereon so as to form a fluid-tight seal between the body 706 and a surrounding structure (e.g., the cover 106 shown in FIG. 1 and the housing 104 shown in FIG. 1). Such materials include, but are not limited to, elastomeric materials (e.g., silicone rubber), or fluoropolymer materials. The ring gaskets 702, 704 can have any shape selected in accordance with a particular filtration system application provided that the shape corresponds to a profile of the flange structure. For example, the ring gaskets 702, 704 can have a circular shape (as shown in FIG. 7), a hex shape (not shown), and/or a rectangular shape (not shown). The ring gaskets 702, 704 can have the same or different diameters.

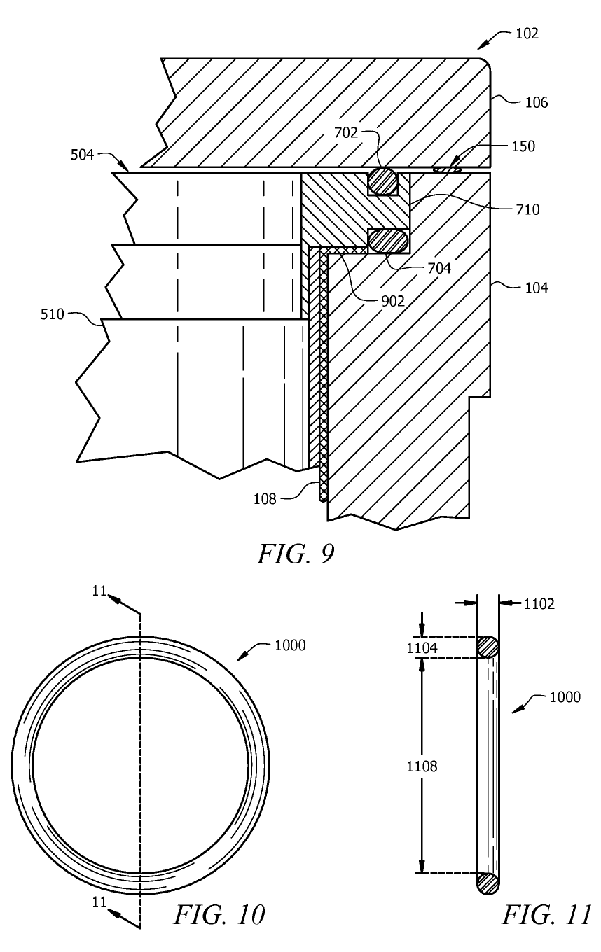

A schematic illustration of the ring gaskets 702, 704 of the filter basket 108 providing fluid-tight seals between the collar 504 and a surrounding structure (e.g., the pressurized filter housing 102 of FIG. 1) is provided in FIG. 9. As shown in FIG. 9, the ring gasket 702 is disposed between the flange 710 of the collar 504 and the cover 106 of the pressurized filter housing 102 so as to form a fluid-tight seal there between. Similarly, the ring gasket 704 is disposed between the flange 710 of the collar 504 and the body 104 of pressurized filter housing 102 so as to form a fluid-tight seal there between. In such as scenario, the filter basket 108 can include a flange 902 absent of ring gaskets (e.g., the ring gaskets 202, 204 of FIGS. 2-3). Alternatively, the filter basket 108 can be absent of a flange 902.

It should be noted that the fluid-tight seals are provided when a pressure (or compressive force) is applied to the collar 504 by the cover 106 of the pressurized filter housing 102. As a result of the fluid-tight seals, the dual ring collar design provides a filtration system 100 with maximum sealing efficiency that is achieved with minimal effort and force.

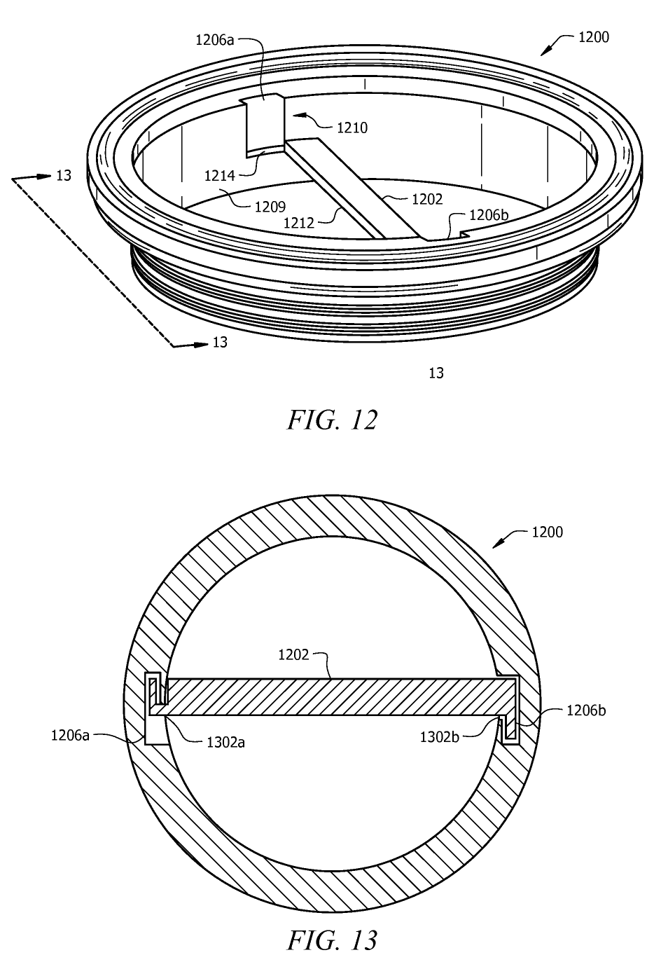

Referring now to FIG. 12, there is provided a perspective view of a collar 1200 having a first exemplary removable and reusable handle 1202 coupled thereto. FIG. 13 is a cross sectional view of the collar 1200 taken along lines 13-13 of FIG. 12. As shown in FIGS. 12 and 13, the collar 1200 has a plurality of substantially L-shaped notches 1206a, 1206b formed in an inner sidewall 1204 thereof. Although two (2) substantially L-shaped notches 1206a, 1206b are shown in FIGS. 12 and 13, embodiments of the present invention are not limited in this regard. For example, the collar 1200 can include any number of sized notches selected in accordance with a particularly handle configuration.

The substantially L-shaped notches 1206a, 1206b can be radially spaced with respect to each other. For example, the substantially L-shaped notches 1206a, 1206b can be spaced one hundred eighty degrees (180°) from each other. Embodiments of the present invention are not limited in this regard. For example, the substantially L-shaped notches 1206a, 1206b can be spaced any number of degrees from each other, where the number of degrees are selected in accordance with a particular handle configuration.

The handle 1202 can include a hook 1302a, 1302b at each opposing end thereof. The hooks 1302a, 1302b are configured to engage the sidewall 1204 of the collar 1200 as shown in FIG. 13. When the hooks 1302a, 1302b engage the sidewall 1204, the handle 1202 is securely coupled to the collar 1200 such that the handle 1202 can be used to insert the collar 1200 into and/or remove the collar 1200 from a filter housing (e.g., the filter housing 102 of FIG. 1).

Notably, the handle 1202 can generally be coupled to the collar 1200 by: (a) aligning the hooks 1302a, 1302b with horizontal portions 1210 of the substantially L-shaped notches 1206a, 1206b; (b) pushing the handle 1202 is a downward direction until a bottom surface 1212 of the handle 1202 abuts a bottom surface 1214 of each substantially L-shaped notch 1206a, 1206b; and (c) rotating the handle 1202 in a clockwise (or counter clockwise) direction.

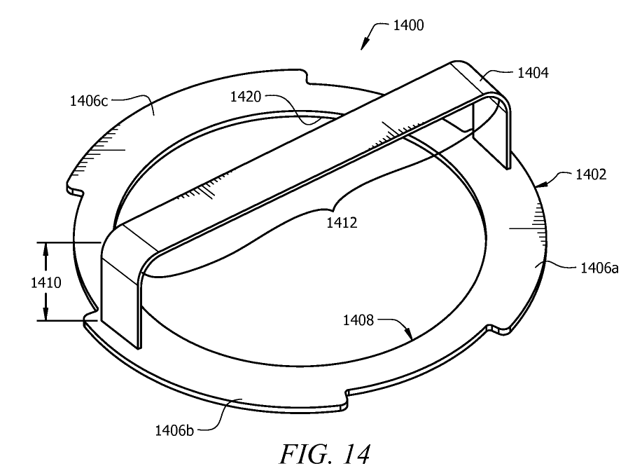

Referring now to FIG. 14, there is provided a perspective view of another exemplary removable and reusable handle 1400 that can be coupled to a collar (not shown) having a plurality of substantially L-shaped notches (not shown) formed in an inner sidewall (not shown) thereof. As shown in FIG. 14, the handle 1400 includes a plate 1402 and a handle member 1404 coupled to the plate 1402. The handle member 1404 can have a substantially U-shaped cross sectional profile as shown in FIG. 14.

The handle member 1404 can have a height 1410 selected in accordance with a particular handle application. For example, the handle member 1404 can have a height such that a top portion 1412 thereof protrudes outward a predefined distance from a top surface (not shown) of a collar (not shown) when the handle 1400 is coupled thereto. In such a scenario, a cover (e.g., the cover 106 shown in FIG. 1) in its closed position (not shown) can apply a downward pressure (or compressive force) on the handle 1400. As a result of the applied pressure (or compressive force), at least one ring gasket (not shown) disposed on the collar (not shown) and/or at least one ring gasket (not shown) disposed on a filter basket (not shown) is compressed so as to form a seal between the collar/filter basket and a surrounding structure.

The plate 1402 has a plurality of protrusions 1406a, 1406b, 1406c extending outward from a main body 1408 thereof. Although three (3) protrusions 1406a, 1406b, 1406c are shown in FIG. 14, embodiments of the present invention are not limited in this regard. The handle 1400 can include any number of protrusions selected in accordance with a particular handle application.

The protrusions 1406a, 1406b, 1406c can be radially spaced with respect to each other. For example, the protrusions 1406a, 1406b, 1406c can be spaced one hundred twenty degrees (120°) from each other. Embodiments of the present invention are not limited in this regard. For example, the protrusions 1406a, 1406b, 1406c can be spaced any number of degrees from each other, where the number of degrees is selected in accordance with a particular handle configuration.

Each of the protrusions 1406a, 1406b, 1406c is configured to engage a sidewall (not shown) of a collar (not shown) so as to couple the handle 1400 to the collar (not shown). When the protrusions 1406a, 1406b, 1406c engage the sidewall (not shown) of the collar (not shown), the removable handle 1400 is securely coupled to the collar (not shown) such that the handle 1400 can be used to insert the collar (not shown) into and/or remove the collar (not shown) from a filter housing (e.g., the filter housing 102 of FIG. 1).

Notably, the handle 1400 can generally be coupled to a collar (not shown) by: (a) aligning the protrusions 1406a, 1406b, 1406c with horizontal portions (not shown) of substantially L-shaped notches (not shown) formed in an inner sidewall (not shown) of a collar (not shown); (b) pushing the handle 1400 is a downward direction until a bottom surface 1420 of the handle 1400 abuts a bottom surface 1214 of each substantially L-shaped notch (not shown); and (c) rotating the handle 1400 in a clockwise or counter clockwise direction.

While various embodiments of the present invention have been described above, it should be understood that they have been presented by way of example only, and not limitation. Numerous changes to the disclosed embodiments can be made in accordance with the disclosure herein without departing from the spirit or scope of the invention. Thus, the breadth and scope of the present invention should not be limited by any of the above described embodiments. Rather, the scope of the invention should be defined in accordance with the following claims and their equivalents.

Although the invention has been illustrated and described with respect to one or more implementations, equivalent alterations and modifications will occur to others skilled in the art upon the reading and understanding of this specification and the annexed drawings. In addition, while a particular feature of the invention may have been disclosed with respect to only one of several implementations, such feature may be combined with one or more other features of the other implementations as may be desired and advantageous for any given or particular application.

The terminology used herein is for the purpose of describing particular embodiments only and is not intended to be limiting of the invention. As used herein, the singular forms “a”, “an” and “the” are intended to include the plural forms as well, unless the context clearly indicates otherwise. Furthermore, to the extent that the terms “including”, “includes”, “having”, “has”, “with”, or variants thereof are used in either the detailed description and/or the claims, such terms are intended to be inclusive in a manner similar to the term “comprising.”

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

The Abstract of the Disclosure is provided to comply with 37 C.F.R. §1.72(b), requiring an abstract that will allow the reader to quickly ascertain the nature of the technical disclosure. It is submitted with the understanding that it will not be used to interpret or limit the scope or meaning of the following claims.

We claim:

1. A filter element assembly for use in a liquid filtering system, comprising:
a collar including a continuous annular sidewall disposed around a central axis and a flange extending radially outward from the annular sidewall including a first face and an opposing second face, each extending traverse to said annular sidewall;
a first ring gasket circumferentially disposed on the first face around the central axis;
a second ring gasket circumferentially disposed on the second face around the central axis; and
a filter element formed from at least one layer that is coextensive with a surface of the filter element, the filter element having a tubular form that is closed at a first end and affixed at a periphery of the tubular form to the annular sidewall at a second end opposed to the first end to define an input orifice of the filter element.

2. The filter element assembly according to claim 1, wherein the first ring gasket is positioned coaxial with the second ring gasket.

3. The filter element assembly according to claim 1, wherein the first and second ring gaskets have the same diameter.

4. The filter element assembly according to claim 1, wherein the first ring gasket has a first diameter different from a second diameter of the second ring gasket.

5. The filter element assembly according to claim 1, wherein the flange further comprises an annular channel formed in the first face sized and shaped for at least partially receiving the first ring gasket.

6. The filter element assembly according to claim 5, wherein the annular channel is defined by a u-shaped recess formed in the surface of the first face.

7. The filter element assembly according to claim 5, wherein the annular channel is defined by a notch formed along a peripheral edge of the first face.

8. The filter element assembly according to claim 1, wherein the flange further comprises a third face extending perpendicularly from the second face having the second sealing member extending radially therearound.

9. The filter element assembly according to claim 8, wherein the second ring gasket is sized and shaped so that an inner circumference of the second sealing member resiliently engages the third face when extended radially therearound.

10. The filter element assembly according to claim 1, wherein at least one of the first and second ring gaskets is formed of a resilient material that can deform in response to a compressive force exerted thereon so as to form a fluid-tight seal between the flange and a portion of a filter housing disposed adjacent to the flange when the filter element assembly is positioned in the filter housing.

11. The filter element assembly according to claim 1, wherein at least one of the first and second ring gaskets is formed of a resilient material that can deform in response to a compressive force exerted thereon so as to form a fluid-tight seal between the flange and a cover of a filter housing disposed adjacent to the flange when the filter element assembly is positioned in the filter housing.

12. The filter element assembly according to claim 1, wherein at least one of the first and second ring gaskets is formed of an elastomeric material or a fluoropolymer material.

13. The filter element assembly according to claim 1, further comprising a removable and reusable handle coupled to the collar via a plurality of L-shaped notches formed in an inner portion of the continuous annular sidewall.

14. An apparatus for filtering fluids, comprising:
a filter housing comprising at least one sidewall defining an interior space configured for receiving a filter element assembly therein;
a cover secured to the filter housing removable from a first position in which said cover encloses said interior space and a second position in which said interior space is accessible for receiving said filter element assembly therein;
a first ring gasket circumferentially disposed around a central axis between the filter housing and the cover so as to provide a first seal therebetween when said cover is in said first position;
said filter element assembly disposed in a channel formed in the filter housing for filtering the fluids, the filter element assembly including
a collar including a continuous annular sidewall disposed around a central axis and a flange extending radially outward from the annular sidewall including a first face and an opposing second face, each extending traverse to said annular sidewall,
a second ring gasket circumferentially disposed on the first face around the central axis providing a second seal between the collar and the cover,
a third ring gasket circumferentially disposed on the second face around the central axis providing a third seal between the collar and the filter housing, and
a filter element formed from at least one layer that is coextensive with a surface of the filter element, the filter element having a tubular form that is closed at a first end and affixed at a periphery of the tubular form to the annular sidewall at a second end opposed to the first end to define an input orifice of the filter element; and
a support structure for supporting the filter element assembly in the filter housing.

15. The apparatus according to claim 14, wherein the second ring gasket is positioned coaxial with the third ring gasket.

16. The apparatus according to claim 14, wherein the second and third ring gaskets have the same diameters.

17. The apparatus according to claim 14, wherein the flange further comprises an annular channel formed in the first face sized and shaped for at least partially receiving the second ring gasket.

18. The filter element assembly according to claim 17, wherein the annular channel is defined by a u-shaped recess formed in the surface of the first face.

19. A filter basket assembly for use in a liquid filtering system, comprising:
a continuous annular sidewall disposed around a central axis;
a flange extending radially outward from the annular sidewall including a first face and an opposing second face, each extending traverse to said annular sidewall;
a first ring gasket circumferentially disposed on the first face around the central axis; and
a second ring gasket circumferentially disposed on the second face around the central axis, the second ring gasket being positioned coaxial with the first ring gasket.

20. An apparatus for filtering fluids, comprising:
a filter housing comprising at least one sidewall defining an interior space configured for receiving a filter element assembly therein;
a cover secured to the filter housing removable from a first position in which said cover encloses said interior space and a second position in which said interior space is accessible for receiving said filter element assembly therein;
a first ring gasket circumferentially disposed around a central axis between the housing and the cover so as to provide a first seal therebetween;
a filter basket removably disposed in the housing, the filter basket comprising a continuous annular sidewall disposed around the central axis and a flange extending radially outward from the annular sidewall including a first face and an opposing second face, each extending traverse to said annular sidewall;
a second ring gasket circumferentially disposed on the first face around the central axis providing a second seal between the collar and the cover; and
a third sealing member circumferentially disposed on the second face around the central axis providing a second seal between the collar and the housing, the third ring gasket being positioned coaxial with the second ring gasket.
